(19) United States
(12) Patent Application Publication
(10) Pub. No.: US 2015/0355706 A1
(43) Pub. Date: Dec. 10, 2015

(54) ELECTRONIC DEVICE AND METHOD FOR CONTROLLING ELECTRONIC DEVICE

(71) Applicant: FUJITSU LIMITED, Kawasaki-shi (JP)

(72) Inventors: Sadao MIYAZAKI, Kawasaki (JP); Osamu ISHIBASHI, Kawasaki (JP); Jin ABE, Kawasaki (JP); Yoshitsugu GOTO, Kawasaki (JP)

(73) Assignee: FUJITSU LIMITED, Kawasaki (JP)

(21) Appl. No.: 14/696,712

(22) Filed: Apr. 27, 2015

(30) Foreign Application Priority Data
Jun. 5, 2014 (JP) 2014-116957

(51) Int. Cl. G06F 1/32; G06F 12/02

(52) U.S. Cl. CPC G06F 1/3287; G06F 12/0246; G06F 2212/7202

(57) ABSTRACT

An electronic device includes: a nonvolatile memory; a volatile memory stacked over the nonvolatile memory; and a controller configured to store setting information of the volatile memory in the nonvolatile memory before cutting off power supply to the volatile memory, and to set the setting information stored in the nonvolatile memory to the volatile memory after resuming power supply to the volatile memory.

### CROSS-REFERENCE TO RELATED APPLICATION

This application is based upon and claims the benefit of priority of the prior Japanese Patent Application No. 2014-116957, filed on Jun. 5, 2014, the entire contents of which are incorporated herein by reference.

### FIELD

The embodiments discussed herein are related to an electronic device and a method for controlling an electronic device.

### BACKGROUND

As storage devices, volatile memories, such as a dynamic random access memory (DRAM) and the like, and nonvolatile memories, such as a magnetoresistive random access memory (MRAM) and the like, have been known. Also, a technique in which a plurality of flat memories (memory cell arrays, memory chips) is stacked to be formed into a three-dimensional structure has been known.

A volatile memory, which is one of storage devices, consumes power for holding storage information and, for example, if the volatile memory has an increased capacity due to being formed into a three-dimensional structure, power consumption may be increased. Thus, if power supply to the volatile memory is cut off when the volatile memory is not used, the power consumption may be reduced.

In such a case, however, when power supply is restarted, it takes a certain time to perform mode register setting, and the like, and put the volatile memory in a usable state, and thus, the processing speed of an electronic device including the volatile memory may be reduced.

The following are reference documents.

[Document 1] Japanese Laid-open Patent Publication No. 2006-318670 and

[Document 2] Japanese Laid-open Patent Publication No. 2009-277334.

### SUMMARY

According to an aspect of the invention, an electronic device includes: a nonvolatile memory; a volatile memory stacked over the nonvolatile memory; and a controller configured to store setting information of the volatile memory in the nonvolatile memory before cutting off power supply to the volatile memory, and to set the setting information stored in the nonvolatile memory to the volatile memory after resuming power supply to the volatile memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a (first) diagram illustrating a first example of an electronic device;

FIG. 2 is a (second) diagram illustrating the first example of an electronic device;

FIG. 3 is a (third) diagram illustrating the first example of an electronic device;

FIG. 4 is a (first) diagram illustrating a second example of an electronic device;

FIG. 5 is a (second) diagram illustrating the second example of an electronic device;

FIG. 6 is a (third) diagram illustrating the second example of an electronic device;

FIG. 7 is a diagram illustrating a configuration example of a memory area of a memory module;

FIG. 8 is a (first) diagram illustrating an example of switch arrangement;

FIG. 9 is a (second) diagram illustrating the example of switch arrangement;

FIG. 10 is a diagram illustrating an example of a management table;

FIG. 11 is a flow chart illustrating an example of switch setting processing flow;

FIG. 12 is a (first) flow chart illustrating an example of a flow of processing performed by an electronic device according to a first embodiment;

FIG. 13 is a (second) flow chart illustrating an example of a flow of processing performed by the electronic device according to the first embodiment;

FIG. 14 is a (first) flow chart illustrating an example of a flow of processing performed by an electronic device according to a second embodiment;

FIG. 15 is a (first) diagram illustrating a third example of an electronic device;

FIG. 16 is a (second) diagram illustrating the third example of an electronic device;

FIG. 17 is a (second) flow chart illustrating an example of a flow of processing performed by the electronic device according to the second embodiment;

FIG. 18 is a (first) diagram illustrating a fourth example of an electronic device;

FIG. 19 is a (second) diagram illustrating the fourth example of an electronic device;

FIG. 20 is a (first) diagram illustrating a fifth example of an electronic device;

FIG. 21 is a (second) diagram illustrating a fifth example of an electronic device; and

FIG. 22 is a flow chart illustrating an example of a flow of processing performed by an electronic device according to a third embodiment.

### DESCRIPTION OF EMBODIMENTS

First, a first embodiment will be described.

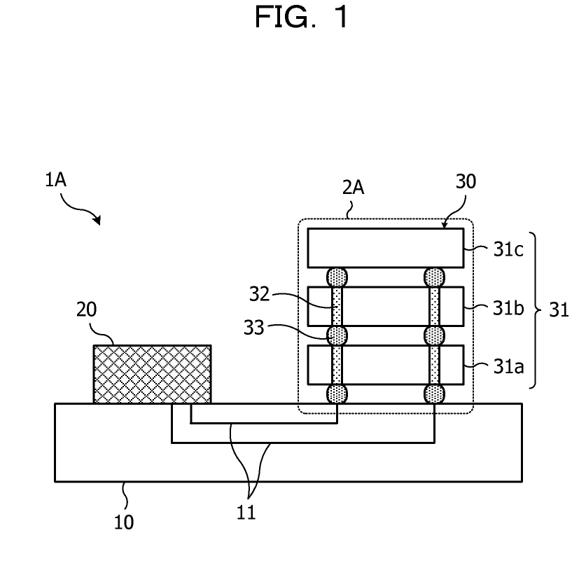

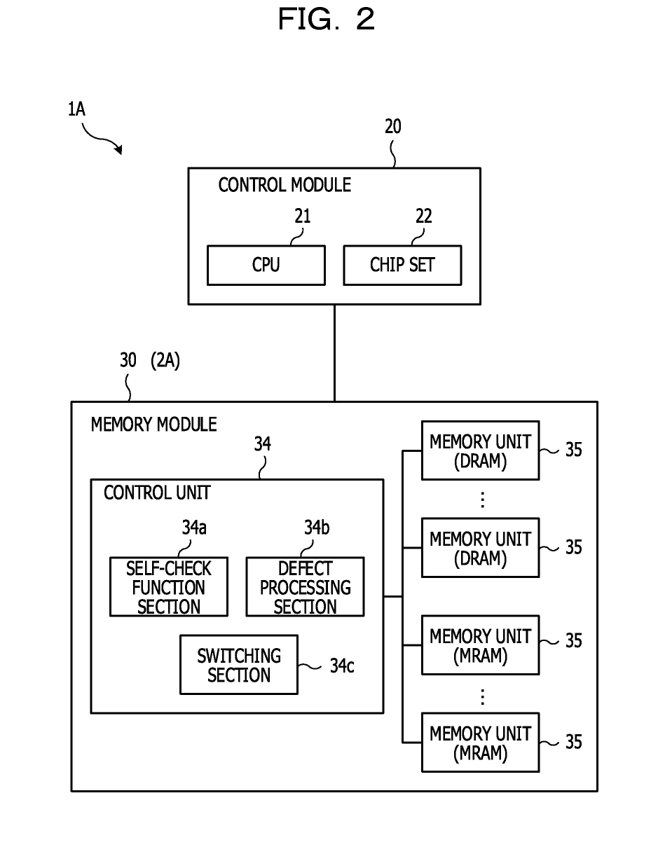

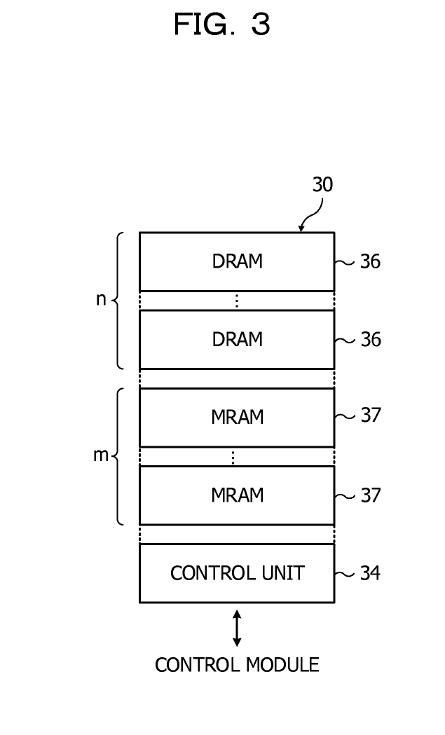

FIG. 1 to FIG. 3 are diagrams illustrating a first example of an electronic device. FIG. 1 is a diagram illustrating an example schematic cross-sectional view of a main portion of an electronic device, FIG. 2 is a diagram illustrating a configuration example of the electronic device, and FIG. 3 is a diagram illustrating a configuration example of a memory module of the electronic device.

An electronic device 1A illustrated in FIG. 1 includes a circuit substrate 10, a control module 20 mounted on the circuit substrate 10, and a memory module 30.

The control module 20 and the memory module 30 are electrically coupled to each other via a wiring 11 provided in the circuit substrate 10. A processing operation of the memory module 30 is controlled by the control module 20.

The memory module 30 includes, for example, a plurality of chips 31 each of which has a memory function. The memory module 30 has a stacked structure 2A of the plurality of chips 31. FIG. 1 illustrates, as an example, three chips 31a, 31b, and 31c. For example, at least one of the plurality of chips 31 is a DRAM, and at least one of the plurality of chips 31 is a MRAM.

The plurality of chips 31 are stacked on the circuit substrate 10 upwardly from the circuit substrate 10, and are electrically coupled to one another. For example, the plurality of stacked chips 31 are electrically coupled one another by a conduction portion 32 that is formed by a through silicon via (TSV) technique, or the like, and provides a conduction between front and back surfaces of the predetermined one of the chips 31 and a connection portion 33 connected to the conduction portion 32.

A switch is provided on a power line that supplies power to each of the chips 31 (a memory block including a certain number of memory cells included therein or a memory layer (a memory cell array) including a certain number of memory blocks). For example, a mechanical switch may be provided in the connection portion 33, and a semiconductor switch formed of a transistor, or the like, may be provided in the chip 31. The electronic device 1A is configured such that supply and cut-off of power to the memory block or the memory layer of the chip 31 may be switched from one to another with the switch. Note that the switch, and supply and cut-off of power using the switch will be described in detail later.

The electronic device 1A will be further described.

The control module 20 includes, for example, as illustrated in FIG. 2, a central processing unit (CPU) 21 and a chip set 22.

The CPU 21 is a processor that controls a processing operation of the entire electronic device 1A or the memory module 30 in the electronic device 1A. The chip set 22 controls information communicated between the CPU 21 and the memory module 30. The chip set 22 outputs, to the memory module 30, various types of information used for controlling the processing operation, based on an instruction of the CPU 21.

The memory module 30 includes, for example, as illustrated in FIG. 2, a control unit 34, and a plurality of memory units 35.

The control unit 34 includes a self-check function section 34a, a defect processing section 34b, and a switching section 34c. The self-check function section 34a performs processing for error detection and error correction for data stored in the memory units 35. The defect processing section 34b performs processing for switching a defect memory cell and memory block to a redundant circuit prepared in the chip 31 in advance. The switching section 34c performs processing for switching supply and cut-off of power to the chip 31 (the memory block or the memory layer) with the switch.

Each of the memory units 35 is a DRAM or MRAM memory block, or a DRAM or MRAM memory layer, and is coupled to the control unit 34.

The memory module 30 of the electronic device 1A may have a hierarchical structure illustrated in FIG. 3, which includes a plurality of (n) DRAM layers 36 and a plurality of (m) MRAM layers 37 that are stacked on the control unit 34.

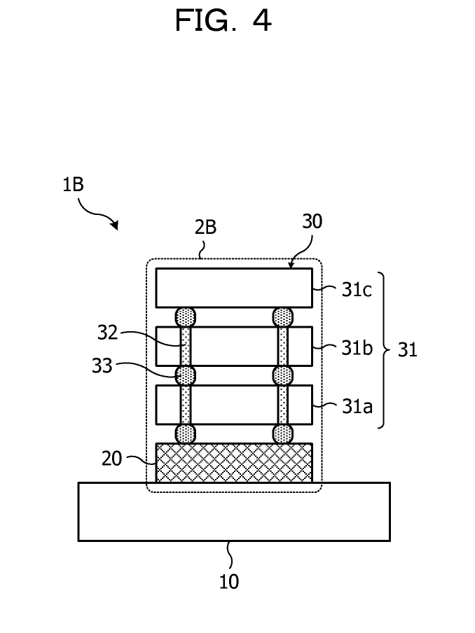

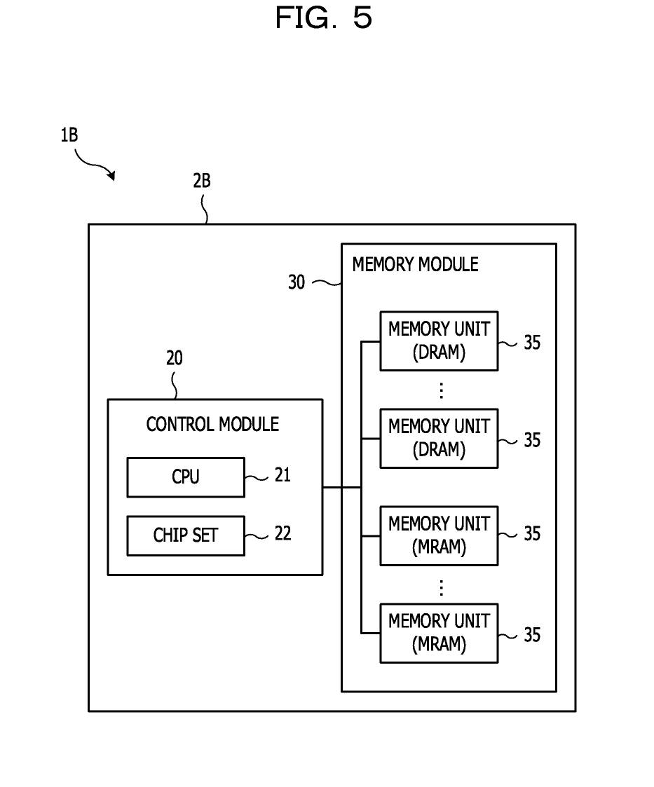

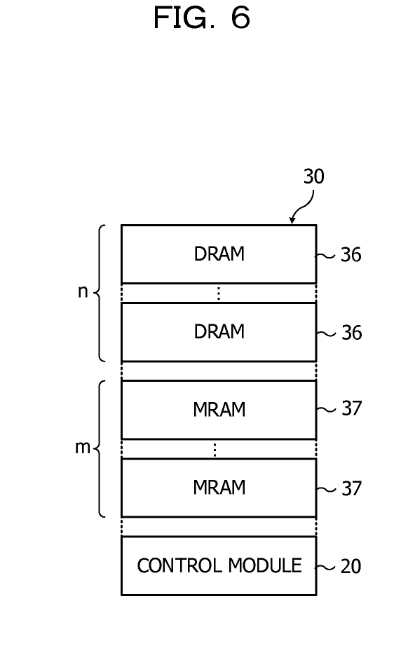

FIG. 4 to FIG. 6 are diagrams illustrating a second example of an electronic device. FIG. 4 is a diagram illustrating an example schematic cross-sectional view of a main portion of an electronic device, FIG. 5 is a diagram illustrating a configuration example of the electronic device, and FIG. 6 is a diagram illustrating a configuration example of a memory module of the electronic device.

An electronic device 1B illustrated in FIG. 4 includes a control module 20 mounted on the circuit substrate 10, and a memory module 30 stacked on the control module 20. A processing operation of the memory module 30 is controlled by the control module 20. The control module 20 and the memory module 30 together form a stacked structure 2B.

The memory module 30 includes, for example, a plurality of chips 31 (three chips 31a, 31b, and 31c, as an example, in this case) each of which has a memory function, at least one of the plurality of chips 31 is a DRAM, and at least one of the plurality of chips 31 is a MRAM. The control module 20 and the plurality of chips 31 of the memory module 30 are electrically coupled to one another by a conduction portion 32 that is formed by a TSV technique, or the like, and a connection portion 33 connected to the conduction portion 32.

A switch, such as a mechanical switch, a semiconductor switch, and the like, is provided on a power line that supplies power to each of the chips 31 (a memory block or a memory layer). The electronic device 1B is configured such that supply and cut-off of power to the memory block or the memory layer of the chip 31 may be switched from one to another. Note that the switch, and supply and cut-off of power using the switch will be described in detail later.

The electronic device 1B will be further described.

The control module 20 includes, for example, as illustrated in FIG. 5, a CPU 21 and a chip set 22. The chip set 22 outputs, to the memory module 30, various types of information used for controlling a processing operation, based on an instruction of the CPU 21. The control module 20 (or the chip set 22 thereof) may include the control unit 34 (the self-check function section 34a, the defect processing section 34b, and the switching section 34c) described in the first example.

The memory module 30 includes, for example, as illustrated in FIG. 5, a plurality of memory units 35. Each of the memory units 35 is a DRAM or MRAM memory block, or a DRAM or MRAM memory layer, and is coupled to the control module 20.

The memory module 30 of the electronic device 1B may have a hierarchical structure illustrated in FIG. 6, which includes a plurality of (n) DRAM layers 36 and a plurality of (m) MRAM layers 37 that are stacked on the control module 20.

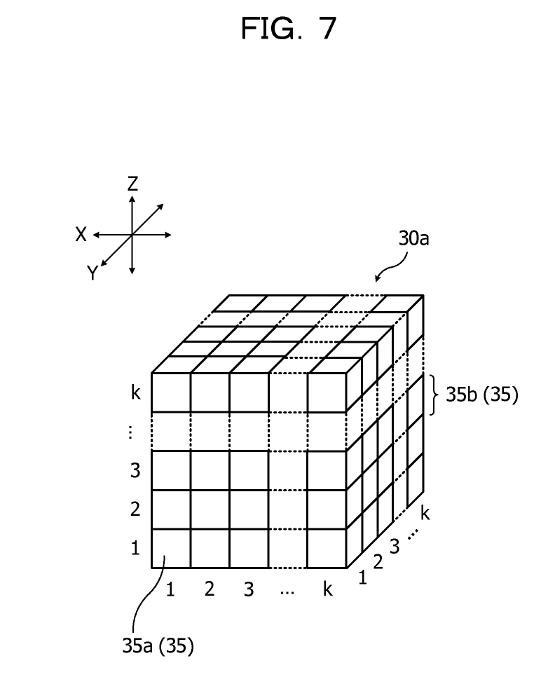

In the electronic device 1A illustrated in the first example and the electronic device 1B illustrated in the second example, the memory module 30 is a three-dimensional memory (a 3D memory) that has a memory area having a three-dimensional structure illustrated in FIG. 7.

FIG. 7 is a diagram illustrating a configuration example of a memory area of a memory module.

As illustrated in FIG. 7, the memory module 30 has a structure that includes a three-dimensional memory area 30a in which a predetermined number of the memory units 35 are arranged in each of X, Y, and Z directions. In FIG. 7, as an example, the memory area 30a in which k memory blocks 35a are arranged in each of the X, Y, and Z directions is illustrated.

For example, a group of the memory blocks 35a arranged in the X and Y directions of a layer (a memory layer 35b) corresponds to a memory block group of the DRAM layers 36, which has been described above, or a memory block group of the MRAM layers 37, which has been described above. In the memory area 30a, for example, a layer (the memory layer 35b) may be a redundant unit that is replaceable for a defect memory unit 35.

Subsequently, the switch will be described.

As described above, the switch that switches supply and cut-off of power to the memory block 35a or the memory layer 35b of each of the chips 31 from one to another is provided on a power line used for supplying power to each of the chips 31 of the memory module 30.

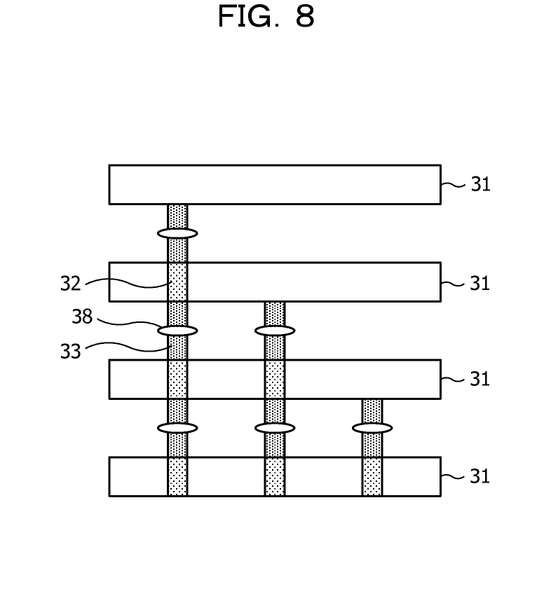

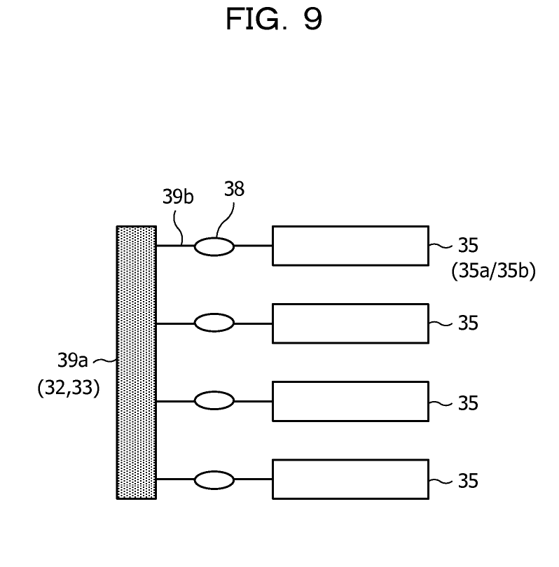

FIG. 8 and FIG. 9 are diagrams illustrating an example of switch arrangement.

For example, as illustrated in FIG. 8, a switch 38 is provided in the connection portion 33 that electrically couples ones of the chips 31 (ones of the chips 31 which include the conduction portion 32, or one of the chips 31 which includes the conduction portion 32 and one thereof which does not include the conduction portion 32) located adjacent to each other in the vertical direction. Thus, supply and cut-off of power to the memory layer 35b of each of the chips 31, or the memory block 35a in the memory layer 35b are switched from one to another.

Also, for example, as illustrated in FIG. 9, a switch 38 is provided on a wiring 39b that electrically coupes an electrode structure 39a including the conduction portion 32 and the connection portion 33 and the corresponding one of the memory units 35 (The memory layers 35b or the memory blocks 35a in the memory layers 35b). Thus, supply and cut-off of power to the memory layer 35b of each of the chips 31, or the memory block 35a are switched from one to another.

In the memory module 30, the switches 38 are provided in the arrangement illustrated in FIG. 8 or FIG. 9, or the switches 38 are provided in an arrangement obtained by combining the arrangements illustrated in FIG. 8 and FIG. 9, so that supply and cut-off of power are switched from one to another in units of the memory layer 35b or in units of the memory blocks 35a.

Thus, switching of supply and cut-off of power for each chip 31 may be performed.

In the electronic device 1A, 1B including the memory module 30, switching on and off of the switches 38 connected to the memory units 35 (the memory layers 35b, the memory blocks 35a) is performed based on an instruction sent from the control module 20.

For example, if power supply to all or some of the memory units 35 in the memory module 30 are cut off, information indicating an instruction to turn off the switches 38 connected to all or some of the memory units 35 is generated by the CPU 21, and is output from the chip set 22. In the memory module 30, the switches 38 indicated in the information output from the chip set 22 are turned off, and power supply to the memory units 35 connected to the switches 38 is cut off.

Also, if power supply to all or some of the memory units 35 in the memory module 30 is started, information indicating an instruction to turn on the switches 38 connected to all or some of the memory units 35 is generated by the CPU 21 and is output from the chip set 22. In the memory module 30, the switches 38 indicated in the information output from the chip set 22 are turned on, and power supply to the memory units 35 connected to the switches 38 is started.

The electronic device 1A, 1B holds, as a management table, information regarding the switches 38 in the memory module 30 in a nonvolatile memory area (for example, the memory area of the MRAM or the memory area of the control unit 34, described above) included in the electronic device 1A, 1B.

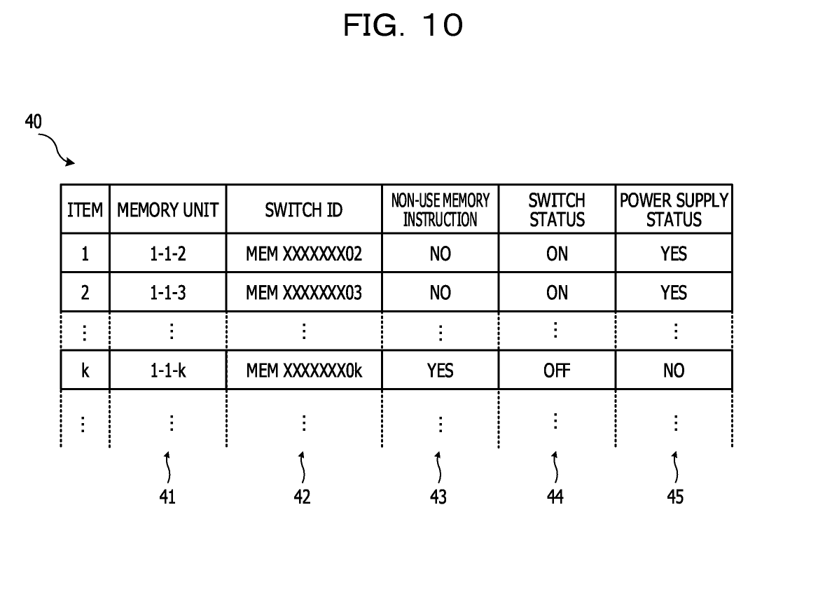

FIG. 10 is a diagram illustrating an example of a management table.

In a management table 40, information (a “MEMORY UNIT” column 41) indicating one of the memory units 35 (the memory layers 35b, the memory blocks 35a) provided in the memory module 30, which is a connection destination of each switch 38, and identification (ID) information (a “SWITCH ID” column 42) given to each switch 38 are recorded. Note that the information indicating the memory unit 35 which is a connection destination of each switch 38 is, for example, the XYZ coordinates (X-Y-Z) of the memory block 35a in the memory area 30a and the Z coordinate (Z) of the memory layer 35b, which are illustrated in FIG. 7.

In the management table 40, information (a “NON-USE MEMORY INSTRUCTION” column 43) indicating whether or not there is an instruction not to perform power supply to the memory units 35, information (a “SWITCH STATUS” column 44″) indicating on and off of the switch 38, and information (a “POWER SUPPLY STATUS” column 45) indicating whether or not power is supplied are recorded.

The CPU 21 or the control unit 34 executes, based on the processing contents, the power consumption, and the like thereof, determination processing of determining whether or not supply or cut-off of power to each of the memory units 35 is to be performed with reference to the management table 40.

Subsequently, processing performed in the electronic device 1A, 1B will be described.

In the electronic device 1A, 1B, setting of the switches 38 is first performed.

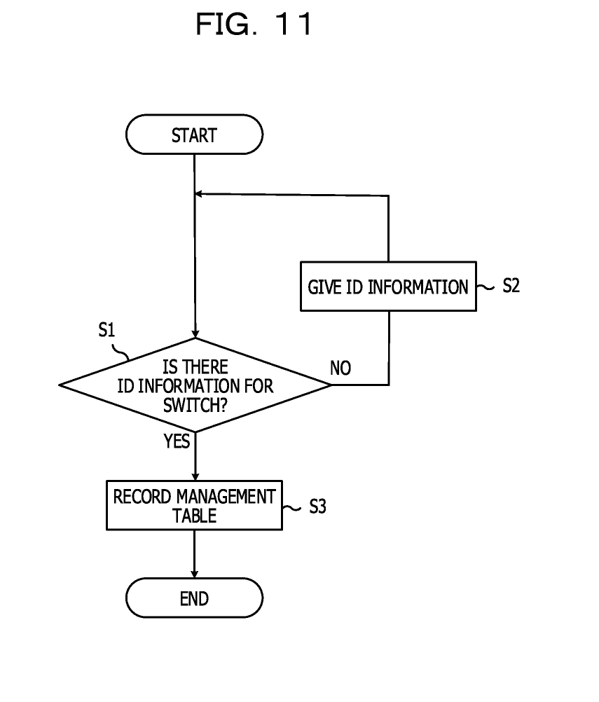

FIG. 11 is a flow chart illustrating an example of switch setting processing flow.

In the electronic device 1A, 1B, after power is supplied, whether or not there is ID information for the switch 38 connected to each of the memory units 35 in the memory module 30 is first checked (Step S1). Based on a check result, ID information is given to the switch 38 for which there is not ID information (Step S2). When power is supplied to the electronic device 1A, 1B for the first time, ID information has not been set for the switch 38 connected to each of the memory units 35, and ID information is given to the switch 38 connected to each of the memory units 35.

ID information given to each switch 38 is recorded in the management table 40 illustrated in FIG. 10 (Step S3). In the management table 40, ID information given to each switch 38 is recorded in association with information indicating the memory units 35, which is a connection destination of each switch 38. In the management table 40, information indicating the non-use memory instruction, the switch status, and the power supply status is further recorded for the memory unit 35 which is a connection destination of each switch 38 to which ID information is given is further recorded.

In the electronic device 1A, 1B, if the status (the non-use memory instruction, the switch status, and the power supply status) of each of the memory units 35 is changed, the record contents of the management table 40 are updated.

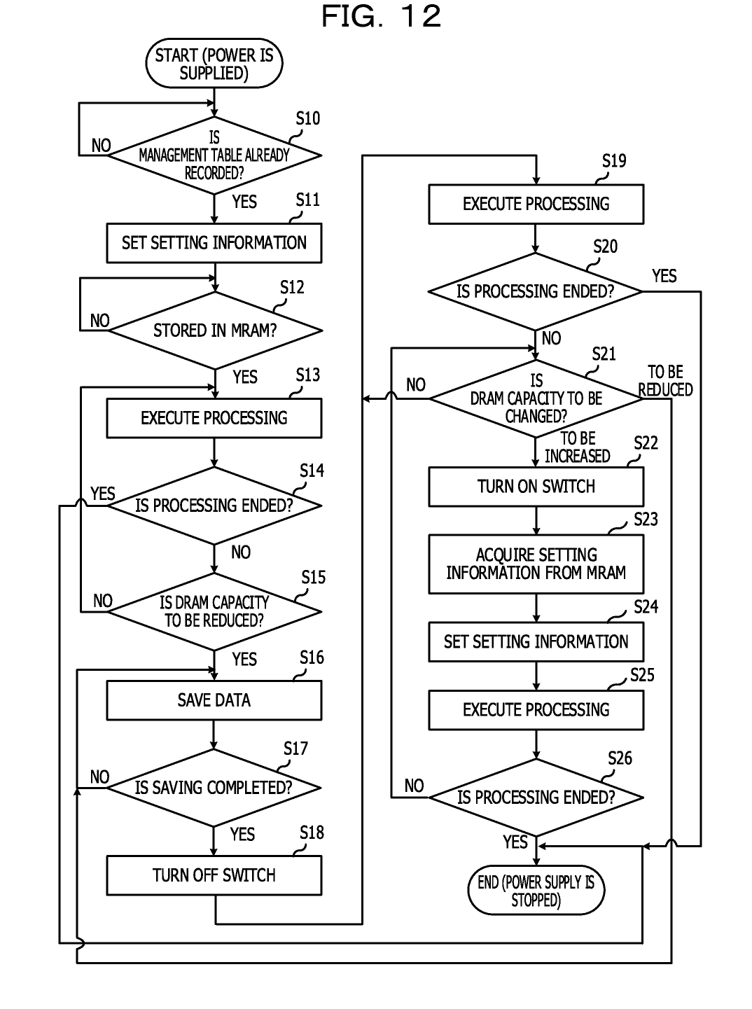

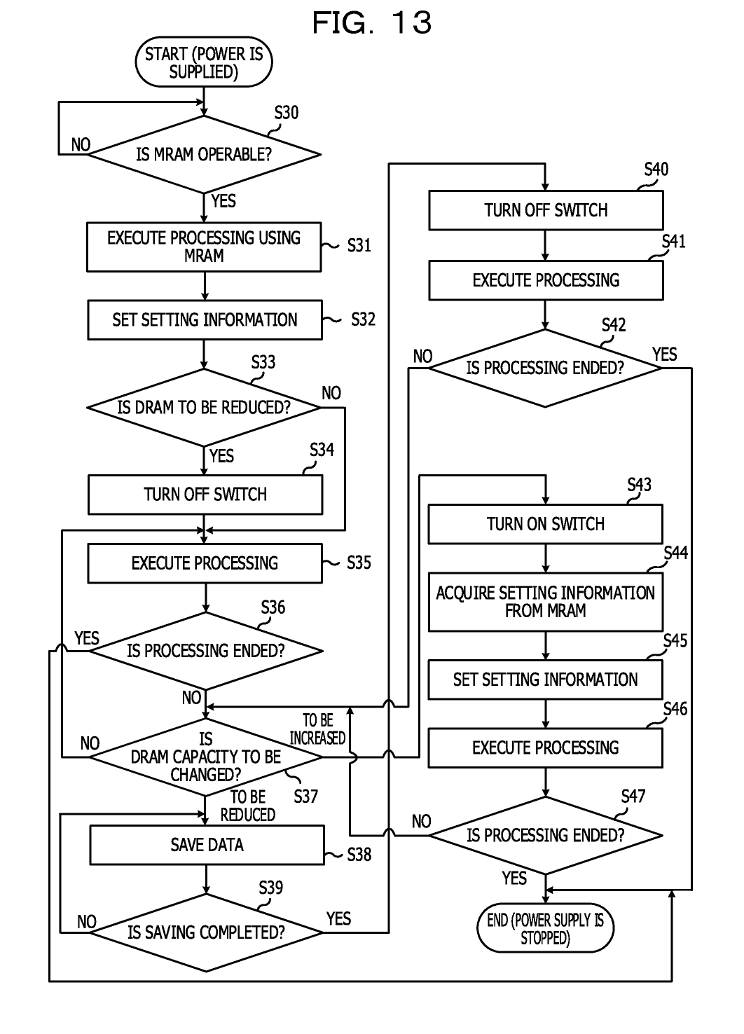

FIG. 12 and FIG. 13 are flow charts illustrating an example of a flow of processing performed by an electronic device according to the first embodiment. FIG. 12 illustrates a flow of processing performed by an electronic device when a first power supply is preformed, and FIG. 13 illustrates a flow of processing performed by the electronic device when second and subsequent power supplies are performed.

First, a flow of processing performed by an electronic device when a first power supply is performed will be described with reference to FIG. 12.

In the electronic device 1A, 1B, when a first power supply is performed, whether or not information (ID information for the switches 38, the non-use memory instruction, the switch status, and the power supply status) of the management table 40 is recorded for all of the memory units 35 in the memory module 30 is first determined (Step S10). If the information of the management table 40 is not recorded for all of the memory units 35 in the memory module 30, the processing of FIG. 11 is executed. Note that, in the management table 40 at the first power supply, information indicating that the non-use memory instruction is “NO”, the switch status is “ON”, and the power supply status is “YES” for all of the memory units 35 (and the switches 38 thereof) in the memory module 30 is recorded.

If information is recorded in the management table 40, in the electronic device 1A, 1B, for the DRAMs of the memory units 35 in the memory module 30, which includes the DRAMs and the MRAMs, setting information used for operations of the DRAMs, such as setting of a mode register, and the like, is performed (Step S11). Then, in the electronic device 1A, 1B, setting information for the DRAMs is stored in the memory areas of the MRAMs of the memory units 35 in the memory module 30 (Step S12).

In the electronic device 1A, 1B, after the setting information for the DRAMs in the memory module 30 is stored in the MRAMs in the above-described manner, the DRAMs corresponding to a maximum capacity are used and various types of processing of the CPU 21 are executed (Steps S13, S14). For example, in the electronic device 1A, 1B, the DRAMs corresponding to the maximum capacity are used as a main storage, and various types of processing of the CPU 21 are executed.

In the electronic device 1A, 1B, determination processing of determining whether or not the capacity of the DRAMs in the memory module 30 is to be reduced from the maximum capacity (whether or not power supply to some of the DRAMs is to be cut off) is executed based on the processing contents, the power consumption, and the like thereof. The management table 40 is used for this determination processing. In the electronic device 1A, 1B, if it is determined that the capacity of the DRAMs is to be reduced, power supplied to some of the DRAMS (the memory layers 35b, the memory blocks 35a) which correspond to an amount by which the capacity is to be reduced is cut off, and therefore, instruction information for instructing to turn off the switches 38 connected to the some of the DRAMs is generated.

In the electronic device 1A, 1B, if instruction information for instructing to turn off the switches 38 connected to the some of the DRAMs is not generated (Step S15), the DRAMs corresponding to the maximum capacity are used, and various types of processing of the CPU 21 are executed (Step S13). If all of the various types of processing of the CPU 21 are ended (Step S14), power supply to the electronic device 1A, 1B is stopped.

On the other hand, in the electronic device 1A, 1B, if instruction information for instructing to turn off the switches 38 connected to the some of the DRAMs is generated (Step S15), the switches 38 indicated in the instruction information are turned off, and power supply to the some of the DRAMs is cut off.

In that case, data stored in some of the DRAMs for which power supply is to be cut off is saved in another memory area in the memory module 30, for example, the memory area of another DRAM, or the memory area of an MRAM (Step S16). Then, whether or not saving data stored in the some of the DRAMs for which for which power supply is to be cut off is completed is determined (Step S17), after the completion of saving, the switches 38 connected to the some of the DRAMs are turned off (Step S18), and power supply to the some of the DRAMs is cut off.

In the electronic device 1A, 1B, after power supply to the some of the DRAMs in the memory module 30 is cut off in the above-described manner, the remaining ones of the DRAMs, except for the some of the DRAMs, are used, and various types of processing of the CPU 21 are executed (Step S19). If all of various types of processing of the CPU 21 are ended (Step S20), power supply to the electronic device 1A, 1B is stopped.

In the electronic device 1A, 1B, as power supply to the some of the DRAMs (the memory layers 35b, the memory blocks 35a) in the memory module 30 is cut off in the manner described above, the record contents of the management table 40 are updated for the some of the DRAMs (and the switches 38 thereof). That is, the record contents for the some of the DRAMs and the switches 38 connected thereto are updated to information indicating that the non-use memory instruction is “YES”, the switch status is “OFF”, and the power supply status is “NO”.

Note that, for the some of DRAMs for which power supply has been cut off in the memory module 30, setting information, such as a mode register and the like, disappears.

In the electronic device 1A, 1B in which power supply to the some of DRAMs is cut off, in a similar manner to that described above, determination processing of determining whether or not the capacity of the DRAMs in the memory module 30 is to be reduced or increased is executed by the CPU 21, based on the processing contents, the power consumption, and the like thereof.

In this determination processing, if it is determined that the capacity of the DRAMs is to be reduced, power supply to other ones of the DRAMs in the memory module 30 is further cut off, and therefore, instruction information for instructing to turn off the switches 38 connected to the other ones of the DRAMs is generated. If the instruction information is generated (Step S21), in the electronic device 1A, 1B, the processing of Step S16 and subsequent steps is executed. Also, in the electronic device 1A, 1B, as power supply is cut off, the record contents of the management table 40 are updated for the other ones of the DRAMs.

On the other hand, in the above-described determination processing, if it is determined that the capacity of the DRAMs is to be increased, power supply to some of the DRAMs in the memory module 30 for which power supply has been cut off is restarted, and therefore, instruction information for instructing to turn on of the switches 38 connected to the some of the DRAMs is generated. If the instruction information is generated (Step S21), in the electronic device 1A, 1B, the following processing is executed.

First, in the electronic device 1A, 1B, the switches 38 connected to the some of the DRAMs for which power supply is restarted are turned on (Step S22). Then, in the electronic device 1A, 1B, for the some of the DRAMs, the setting information set in Step S11 and stored in the MRAMs in Step S12 is acquired from the MRAMs (Step S23), and the acquired setting information is set in the some of the DRAMs (Step S24). Also, in the electronic device 1A, 1B, as power supply is restarted, the record contents of the management table 40 are updated for the some of the DRAMs.

Thereafter, in the electronic device 1A, 1B, the DRAMs to which power is supplied are used, and the various types of processing of the CPU 21 are executed (Step S25). If all of the various types of processing of the CPU 21 are ended (Step S26), power supply to the electronic device 1A, 1B is stopped. If all of the various types of processing of the CPU 21 are not ended (Step S26), the processing of Step S21 and subsequent steps is executed.

Also, in the electronic device 1A, 1B, if it is determined that the capacity of the DRAMs is not to be changed in the determination processing of Step S21, the processing of Step S19 and subsequent steps is executed.

Note that, if power supply to the electronic device 1A, 1B is stopped (Steps S14, S20, and S26), setting information for the DRAMs in the memory module 30 at that time point may be stored in the MRAMs anew.

Control (processing, management and the like) of the memory units 35 may be performed by the control unit 34 in accordance with an instruction of the CPU 21.

In the electronic device 1A, 1B, when power supply to some of the DRAMs in the memory module 30 is resumed for which power supply has been cut off and setting information has disappeared, the setting information stored in the MRAMs is reflected in the some of the DRAMs. Therefore, as compared to a case where, when power supply is restarted, setting of the mode registers or the like for the some of the DRAMs is performed anew, a time which it takes for the DRAMs to be put in a useable state is reduced.

As described above, if power supply to some of DRAMs for which power supply has once been cut off is resumed, the DRAMs may be quickly started up and the capacity may be increased, so that reduction in the speed and reliability of processing using the DRAMs in the electronic device 1A, 1B may be reduced.

In the electronic device 1A, 1B, on processing thereof, some of the DRAMs in the memory module 30 are not used, power supply to the some of the DRAMs may be kept cut off. Therefore, reduction in power consumption of the DRAMs in the memory module 30 and reduction in power consumption of the electronic device 1A, 1B may be achieved.

Subsequently, a flow of processing performed by an electronic device when second and subsequent power supplies are performed will be described with reference to FIG. 13.

In the electronic device 1A, 1B, for example, when, after a first power supply is stopped, a second power supply is performed, whether or not the MRAMs of the memory units 35 in the memory module 30 are in an operable state is first determined by the CPU 21 (Step S30). In electronic devices 1A and 1B, the MRAMs are first used and various types of processing of the CPU 21 are executed (Step S31).

In parallel to this, in the electronic device 1A, 1B, among the memory units 35, including the DRAMs and the MRAMs, in the memory module 30, for the DRAMs, the setting information set in Step S11 and stored in the MRAMs in Step S12 is set (Step S32). Note that, if the setting information is stored anew in the MRAMs when the first power supply was stopped, the setting information may be set in the DRAMs in the memory module 30.

As described above, in the electronic device 1A, 1B, when a second power supply is performed, the MRAMs, not the DRAMs, are first used to execute processing and, in parallel with that, for the DRAMs, the setting information stored in the MRAMs is reflected. In the electronic device 1A, 1B, setting information is set in the DRAMs and, until the DRAMs are put in a usable state, the MRAMs are used and various types of processing of the CPU 21 are executed.

It takes a certain time to set setting information, such as a mode register, and the like, for the DRAMs. Therefore, if processing is performed using only the DRAMs after a second power supply is performed, a situation where processing using the DRAMs is not performed until setting of the setting information is completed or a situation where processing is not performed with high reliability might occur. In order to cope with such a situation, as described above, after a second power supply is performed, processing is first executed using the MRAMs and, in parallel with that, setting information is set in the DRAMs, so that processing may be quickly started, and reduction in the speed and reliability of processing may be reduced.

In the electronic device 1A, 1B, after the setting information for the DRAMs is set in the manner described above, or in parallel with the setting being performed, determination processing of determining whether or not the capacity of the DRAMs in the memory module 30 is to be reduced is executed by the CPU 21, based on the processing contents, the power consumption, and the like thereof. If it is determined that the capacity of the DRAMs is to be reduced, power supply to some of the DRAMs in the memory module 30 is cut off, and therefore, instruction information for instructing to turn off the switches 38 connected to the some of the DRAMs is generated.

In the electronic device 1A, 1B, if instruction information for instructing to turn off the switches 38 connected to the some of the DRAMs is generated (the capacity of the DRAMs is to be reduced) (Step S33), the switches 38 indicated in the instruction information are turned off (Step S34). Then, the remaining ones of the DRAMs, except for the some of the DRAMs, which are put in a usable state, are used, and various types of processing of the CPU 21 are executed (Step S35). If all of various types of processing of the CPU 21 are ended (Step S36), power supply to the electronic device 1A, 1B is stopped.

On the other hand, if instruction information is not generated (the capacity of the DRAMs is not to be reduced) (Step S33), the DRAMs corresponding to the maximum capacity, which are in a usable state, are used, and various types of processing of the CPU 21 are executed (Step S35). If all of various types of processing of the CPU 21 are ended (Step S36), power supply to the electronic device 1A, 1B is stopped.

In the electronic device 1A, 1B in which various types of processing are executed, in a similar manner to that described above, determination processing of determining whether the capacity of the DRAMs in the memory module 30 is to be reduced or increased is executed by the CPU 21, based on the processing contents, the power consumption, and the like thereof, and instruction information based on a determination result is generated.

In the electronic device 1A, 1B, if instruction information for instructing to turn off the switches 38 connected to some of the DRAMs is generated in order to reduce the capacity of the DRAMs (Step S37), the following processing is executed.

First, data stored in the some of the DRAMs for which the corresponding switches 38 are turned off is saved in another memory area in the memory module 30, for example, the memory area of another DRAM, or the memory area of an MRAM (Step S38). Then, whether or not saving of data stored in the some of the DRAMs is completed is determined (Step S39). After the completion of saving, the switches 38 indicated by the instruction information are turned off (Step S40), and power supply to the some of the DRAMs is cut off. Also, in the electronic device 1A, 1B, as the power supply is curt off, the record contents of the corresponding part of the management table 40 are updated.

In the electronic device 1A, 1B, after power supply to the some of DRAMs is cut off in the above-described manner, the remaining ones of the DRAMs, except for the some of the DRAMs for which power supply was cut off, are used, and various types of processing of the CPU 21 is executed (Step S41). If all of various types of processing of the CPU 21 are ended (Step S42), power supply to the electronic device 1A, 1B is stopped.

On the other hand, if instruction information for instructing to turn on the switches 38 connected to some of the DRAMs is generated in order to increase the capacity of the DRAMs (Step S37), the following processing is executed.

First, in the electronic device 1A, 1B, the switches 38 connected to some of the DRAMs in the memory module 30, for which the corresponding switches 38 are to be turned on, are turned on (Step S43). Then, in the electronic device 1A, 1B, for the some of the DRAMs, setting information is acquired from the MRAMs (Step S44), and the acquired setting information is set in the some of the DRAMs (Step S45). Also, in the electronic device 1A, 1B, as power supply is restarted, the record contents of the corresponding part of the management table 40 are updated.

Thereafter, in the electronic device 1A, 1B, ones of the DRAMs to which power is supplied are used, and various types of processing of the CPU 21 are executed (Step S46). If all of various types of processing of the CPU 21 are ended (Step S47), power supply to the electronic device 1A, 1B is stopped. If all of various types of processing of the CPU 21 are not ended (Step S47), the processing of Step S37 and subsequent steps is executed.

Also, in the electronic device 1A, 1B, in Step S37, if it is determined that the capacity of the DRAMs is not to be changed, the processing of Step S35 and subsequent steps is executed.

Note that, when power supply to the electronic device 1A, 1B is stopped (Steps S36, S42, and S47), setting information for the DRAMs in the memory module 30 at that time point may be stored anew in the MRAMs.

Control (processing, management, and the like) of the memory units 35 may be performed by the control unit 34 in accordance with an instruction of the CPU 21.

A flow of processing performed after a second power supply to the electronic device 1A, 1B is performed has been described herein as an example, but after third and subsequent power supplies to the electronic device 1A, 1B are performed, the processing flow illustrated in FIG. 13 is also executed.

In recent years, for information processing units, such as a server, a super computer, and the like, reduction in power consumption has been urged, and as one of techniques for realizing reduction in power consumption, normally-off computing has drawn attention. In response to such demands for reduction in power consumption, the method described in the first embodiment enables realization of reduction in power consumption at the electronic device level and realization of increase in capacity of a memory, such a DRAM, and the like.

For example, in an electronic device including a large capacity DRAM chip or a large capacity DRAM in which a plurality of DRAM chips are stacked, setting information, such as a mode register, and the like, for the large capacity DRAM is stored in an MRAM provided in the electronic device in advance. Then, power supply to some of DRAMs, which are not used for performing processing, is cut off and, when the some of DRAMs are used for performing processing, power supply to the some of the DRAMS is restarted. Thus, even for the electronic device including a large capacity DRAM, power consumption may be reduced. When power supply to the some of the DRAMs is restarted, setting information stored in the MRAM in advance is reflected in the some of the DRAMs. Thus, the DRAMs for which power supply has been cut off once and then is restarted may be quickly put in a usable state.

Using the method described in the first embodiment, even when the electronic device 1A, 1B includes a large capacity DRAM, power supply may be cut off to reduce power consumption, and DRAMs for which power supply is restarted may be started up in an early stage to reduce reduction in the speed and the reliability of processing.

Note that, in the first embodiment, a DRAM has been illustrated as a volatile memory, but as a volatile memory, in addition to various types of DRAMs, such as a synchronous dynamic random access memory (SDRAM) and the like, a static random access memory (SRAM), or the like, may be used. Also, in the first embodiment, an MRAM has been illustrated as a nonvolatile memory, but another nonvolatile memory, such as a NAND type or NOR type flash memory, and the like, may be used.

Also, in the first embodiment, a case where the capacity of DRAMs is changed has been described as an example, but in accordance with the example of DRAMs, for a nonvolatile memory, such as an MRAM and the like, the switch 38 connected thereto may be changed to change the capacity thereof.

Next, a second embodiment will be described.

In an electronic device including DRAMs, for example, in accordance with its use, the DRAM capacity thereof is set to be 2 GB, 4 GB, and 8 GB. In such a case, if each of DRAMs having 2 GB, 4 GB, and 8 GB is developed or manufactured, or if a 3D memory is developed or manufactured by stacking DRAM chips such that each of 2 GB, 4 GB, and 8 GB is achieved, the cost of development and the cost of production for an electronic device and a system using the electronic device are likely to be increased.

On the other hand, in the electronic device 1A, 1B, the target DRAM capacity may be realized by switching the switches 38. In this case, such a method will be described as the second embodiment.

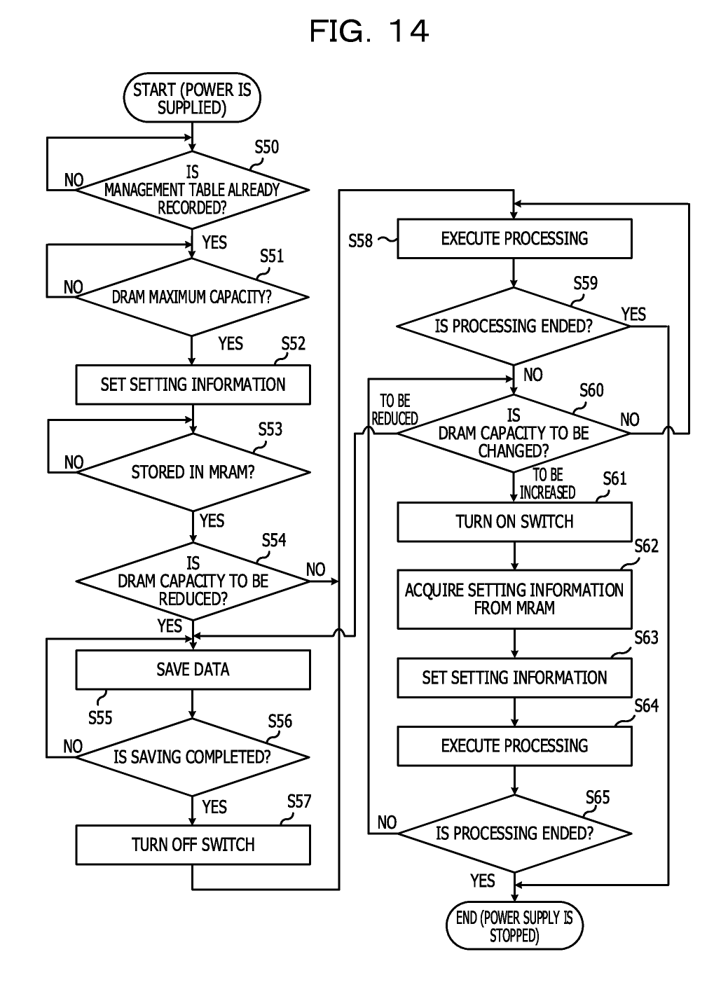

FIG. 14 is a flow chart illustrating an example of a flow of processing performed by an electronic device according to the second embodiment.

In the electronic device 1A, 1B, first, whether or not information (ID information for the switches 38, the non-use memory instruction, the switch status, and the power supply status) of the management table 40 is recorded for all of the memory units 35 in the memory module 30 is determined (Step S50). If the information of the management table 40 is not recorded for all of the memory units 35 in the memory module 30, the processing of FIG. 11 is executed.

If information is recorded in the management table 40, in the electronic device 1A, 1B, for the DRAMs of the memory units 35 in the memory module 30 including the DRAMs and the MRAMs, whether or not the capacity thereof is set to be a maximum capacity is determined (Step S51).

Then, in the electronic device 1A, 1B, for the DRAMs the capacity of which is set to be a maximum capacity, setting information, such as a mode register and the like, is set (Step S52), and setting information for the DRAMs is stored in the memory areas of the MRAMs of the memory units 35 in the memory module 30 (Step S53).

In the electronic device 1A, 1B, information that specifies the capacity of the DRAMs is input. For example, if the memory module 30 including DRAMs of 8 GB at maximum is desired to be used as a memory of 2 GB or 4 GB, information that specifies the capacity is input to the electronic device 1A, 1B.

For example, a manufacturer or a user uses a predetermined input unit (a computer, and a keyboard, a pointing device, or the like, connected to the computer,) to input information that specifies the capacity for the electronic device 1A, 1B, or an electronic equipment including the electronic device 1A, 1B. In the electronic device 1A, 1B, based on the input information, whether or not the capacity of the DRAMs in the memory module 30 is to be reduced from the maximum capacity is determined by the CPU 21 (Step S54). Based on this determination, instruction information indicating whether or not the capacity of the DRAMs is to be changed and, if the capacity is to be changed, the capacity (a specified capacity) of the DRAMs after being changed, and the switches 38 which are to be turned off in order to achieve the specified capacity is generated.

In the electronic device 1A, 1B, based on the instruction information, if the capacity of the DRAMs is to be reduced, data stored in ones of the DRAMs (the memory layers 35b, the memory blocks 35a) which are non-use DRAMs the capacity of which is different from the specified capacity indicated by the instruction information is saved in another memory area (Step S55). After the completion of saving (Step S56), the switches 38 connected to the non-use DRAMs are turned off (Step S57), and power supply to the non-use DRAMs is cut off. Note that, if data is not stored in the DRAMs, Steps S55 and S56 may be skipped. Also, in the electronic device 1A, 1B, as power supply is cut off, the record contents of the corresponding part of the management table 40 are updated.

In the electronic device 1A, 1B, after power supply is cut off in the above-described manner, the DRAMs of the specified capacity are used and various types of processing of the CPU 21 are executed (Step S58). If all of the various types of processing of the CPU 21 are ended (Step S59), power supply to the electronic device 1A, 1B is stopped.

The electronic device 1A, 1B including the memory module 30 that includes the DRAMs of the specified capacity may be realized by the above-described processing.

Also, in the electronic device 1A, 1B, the capacity of the DRAMs may be further changed. In the electronic device 1A, 1B, if information that specifies the capacity anew is input thereto, based on the input information, instruction information indicating the specified capacity of the DRAMs and the switches 38 which are to be turned on or off in order to achieve the specified capacity is generated, and the processing of Step S60 and subsequent steps is executed.

That is, in the electronic device 1A, 1B, based on the instruction information, if the capacity of the DRAMs in the memory module 30 is to be reduced (Step S60), the processing of Step S55 and subsequent steps is executed.

On the other hand, in the electronic device 1A, 1B, based on the instruction information, if the capacity of the DRAMs in the memory module 30 is to be increased (Step S60), the switches 38 connected to ones of the DRAMs for which power supply is restarted are first turned on (Step S61). Then, in the electronic device 1A, 1B, for the ones of the DRAMs, setting information is acquired from the MRAMs (Step S62), and the acquired setting information is set in the ones of the DRAMs (Step S63). Also, in the electronic device 1A, 1B, as power supply is restarted, the record contents of the corresponding part of the management table 40 are updated.

In the electronic device 1A, 1B, ones of the DRAMs to which power is supplied are used, and various types of processing of the CPU 21 are executed (Step S64). If all of various types of processing of the CPU 21 are ended (Step S65), power supply to the electronic device 1A, 1B is stopped. If all of various types of processing of the CPU 21 are not ended (Step S65), the processing of Step S60 and subsequent steps is executed.

Also, in the electronic device 1A, 1B, in Step S60, if the capacity of the DRAMs is not to be changed, the processing of Step S58 and subsequent steps is executed.

Note that, when power supply to the electronic device 1A, 1B is stopped (Steps S59 and S65), setting information for the DRAMs in the memory module 30 at that time point may be stored anew in the MRAMs.

Using the method described in the second embodiment, the capacity of the DRAMs in the memory module 30 of the electronic device 1A, 1B may be changed in accordance with its use, or the like, and the electronic device 1A, 1B that may correspond to various capacities may be realized. The electronic device 1A, 1B is configured such that the capacity of the DRAMs in the memory module 30 may be changed, and thus, as compared to a case where each of electronic devices having memories of different capacities mounted therein is developed and manufactured, increase in the cost of development and the cost of manufacturing may be reduced.

In the second embodiment, in the electronic device 1A, 1B, power supply to ones of the non-use DRAMs, which are not used, may be cut off, and also, when the ones of the DRAMs are used, setting information stored in the MRAMs may be reflected in the ones of the DRAMs for which power supply is restarted, and the ones of the DRAMs may be quickly put in a usable state. Even when the electronic device 1A, 1B includes a large capacity DRAM, power supply may be cut off to reduce power consumption, and the DRAMs, for which power supply is restarted, may be started up in an early stage to reduce reduction in the speed and the reliability of processing.

Note that, in the second embodiment, a DRAM has been illustrated as a volatile memory, but as a volatile memory, in addition to various types of DRAMs, such as an SDRAM and the like, an SRAM, or the like, may be used. Also, in the second embodiment, an MRAM has been illustrated as a nonvolatile memory, but another nonvolatile memory, such as a NAND and the like, may be used.

Also, in the second embodiment, a case where the capacity of DRAMs is changed has been described as an example, but in accordance with the example of DRAMs, for a nonvolatile memory, such as MRAMs and the like, the switches 38 connected thereto may be changed to change the capacity thereof.

A case where setting information for DRAMs is stored in MRAMs in advance and, when power supply to the DRAMs is restarted, the setting information stored in the MRAMs is reflected in the DRAMs for which power supply is restarted has been illustrated herein. As another case, if it is intended to change the capacity of DRAMs, there may be cases where MRAMs are not provided.

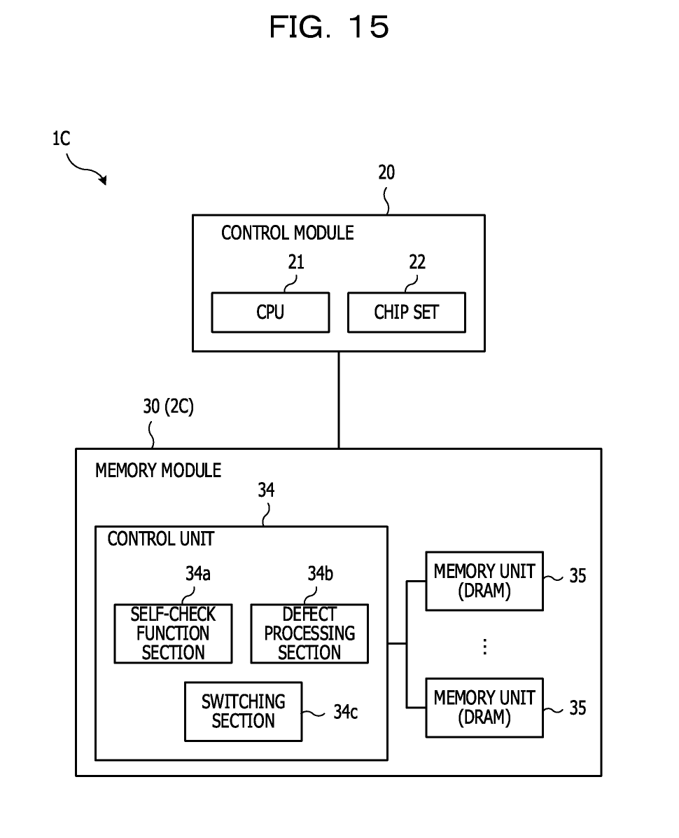

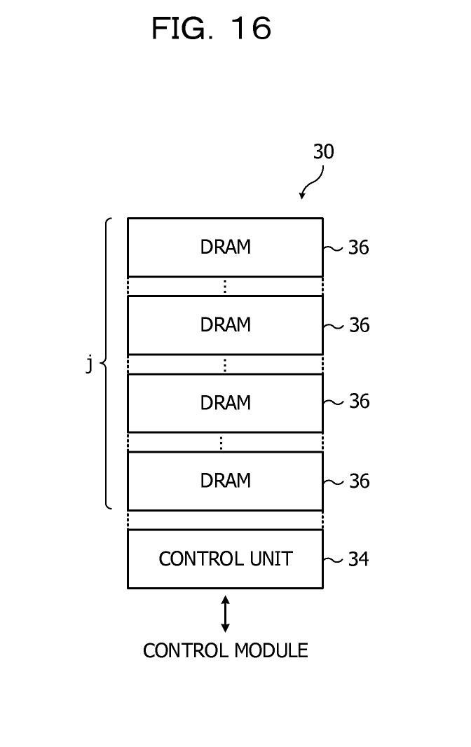

FIG. 15 and FIG. 16 are diagrams illustrating a third example of an electronic device. FIG. 15 is a diagram illustrating a configuration example of the electronic device, and FIG. 16 is a diagram illustrating a configuration example of a memory module of the electronic device.

An electronic device 1C illustrated in FIG. 15 includes a control module 20 and a memory module 30 having a stacked structure 2C. The electronic device 1C is different from the above-described electronic device 1A in that the electronic device 1C includes memory units 35 (memory blocks and memory layers) of DRAMs but does not include memory units of MRAMs in the memory module 30. As illustrated in FIG. 16, the memory module 30 of the electronic device 1C may have a hierarchical structure including a plurality of (j) DRAM layers 36 that are stacked on the control unit 34.

In the memory module 30 of the electronic device 1C, a memory area 30a having a three-dimensional structure illustrated in FIG. 7 is realized by DRAMs. In the memory module 30 of the electronic device 1C, the switches 38 are provided in the arrangement illustrated in FIG. 8 or FIG. 9, or in an arrangement obtained by combining the arrangements illustrated in FIG. 8 and FIG. 9, so that switching of supply and cut-off of power in units of the memory layer 35b or in units of the memory blocks 35a is enabled.

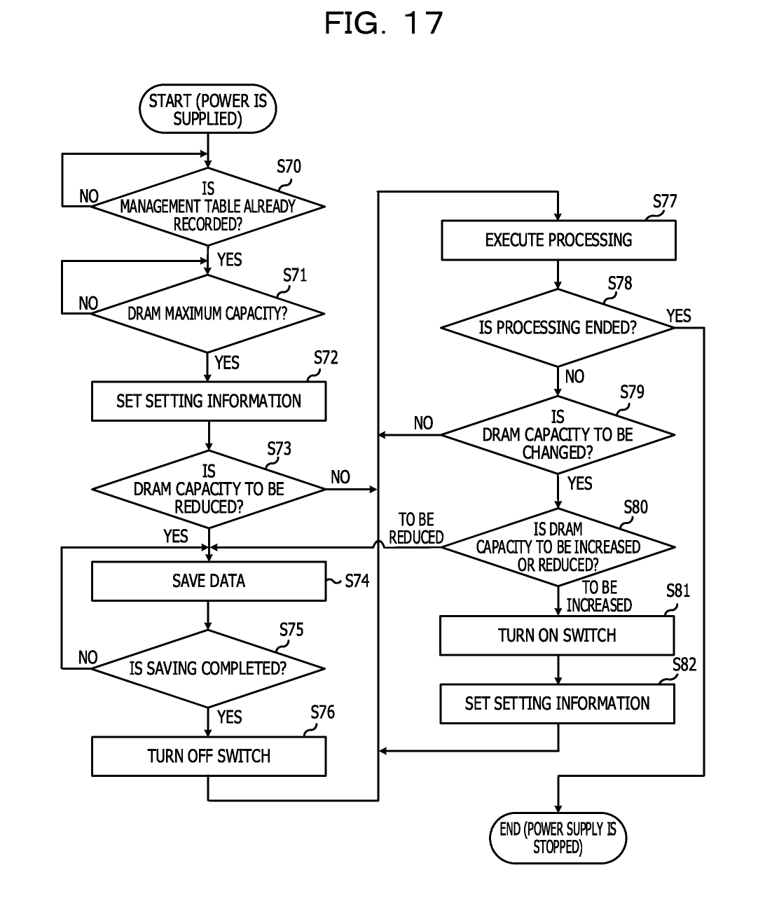

An example of a flow of DRAM capacity changing processing performed in the electronic device 1C having the above-described structure will be illustrated in FIG. 17.

In the electronic device 1C, first, whether or not information (ID information for the switches 38, the non-use memory instruction, the switch status, and the power supply status) of the management table 40 is recorded for all of the memory units 35 in the memory module 30 is determined (Step S70). If the information of the management table 40 is not recorded for all of the memory units 35 in the memory module 30, the processing of FIG. 11 is executed.

If information is recorded in the management table 40, in the electronic device 1C, for the DRAMs of the memory units 35 in the memory module 30, whether or not the capacity thereof is set to be a maximum capacity (Step S71).

In the electronic device 1C, for ones of the DRAMs for which the capacity is set to be a maximum capacity, setting information, such as a mode register and the like, is set (Step S72).

The electronic device 1C is configured such that information that specifies the capacity of the DRAMs is input thereto by a manufacturer, a user, or the like. In the electronic device 1C, based on the input information, whether or not the capacity of the DRAMs in the memory module 30 is to be reduced from a maximum capacity is determined by the CPU 21 (Step S73). Based on this determination, instruction information indicating whether or not the capacity of the DRAMs is to be changed and, if the capacity is to be changed, the specified capacity of the DRAMs and the switches 38 which are to be turned off in order to achieve the specified capacity is generated.

In the electronic device 1C, based on the instruction information, if the capacity of the DRAMs is to be reduced, data stored in non-use DRAMs (the memory layers 35b, the memory blocks 35a) the capacity of which is different from the specified capacity indicated by the instruction information is saved in another memory area (Step S74). After the completion of saving (Step S75), the switches 38 connected to the non-use DRAMs are turned off (Step S76), and power supply to the non-use DRAMs is cut off. Note that, if data is not stored in the DRAMs, Steps S74 and S75 may be skipped. Also, in the electronic device 1C, as power supply is cut off, the record contents of the corresponding part of the management table 40 are updated.

In the electronic device 1C, after power supply is cut off in the above-described manner, one of the DRAMs of the specified capacity are used and various types of processing of the CPU 21 are executed (Step S77). If all of the various types of processing of the CPU 21 are ended (Step S78), power supply to the electronic device 1C is stopped.

In the electronic device 1C, in Step S73, if the capacity of the DRAMs is not to be reduced, based on the instruction information, the processing of Step S77 and subsequent steps is executed.

Also, in the electronic device 1C, if information that specifies the capacity is input anew (Step S79), based on the input information, instruction information indicating the specified capacity of the DRAMs and the switches 38 which are to be turned on or off in order to achieve the specified capacity is generated, and the following processing is executed.

That is, in the electronic device 1C, based on the instruction information, if the capacity is to be reduced (Step S80), the processing of Step S74 and subsequent steps is executed. In the electronic device 1C, based on the instruction information, if the capacity is to be increased (Step S80), the switches 38 connected to ones of the DRAMs for which power supply is restarted are turned on (Step S81) and, for the ones of the DRAMs, setting information, such as a mode register and the like, is set (Step S82). Note that, in Step S81, the switches 38 connected to all of the DRAMs in the memory module 30 are turned on, and in Step S82, for all of the ones of the DRAMs, setting information, such as a mode register and the like, may be set. In the electronic device 1C, after the setting information is set, the processing of Step S77 and subsequent steps is executed.

As described above, even when MRAMs are not provided in the memory module 30, the capacity of the DRAMs in the memory module 30 may be changed.

Next, a third embodiment will be described.

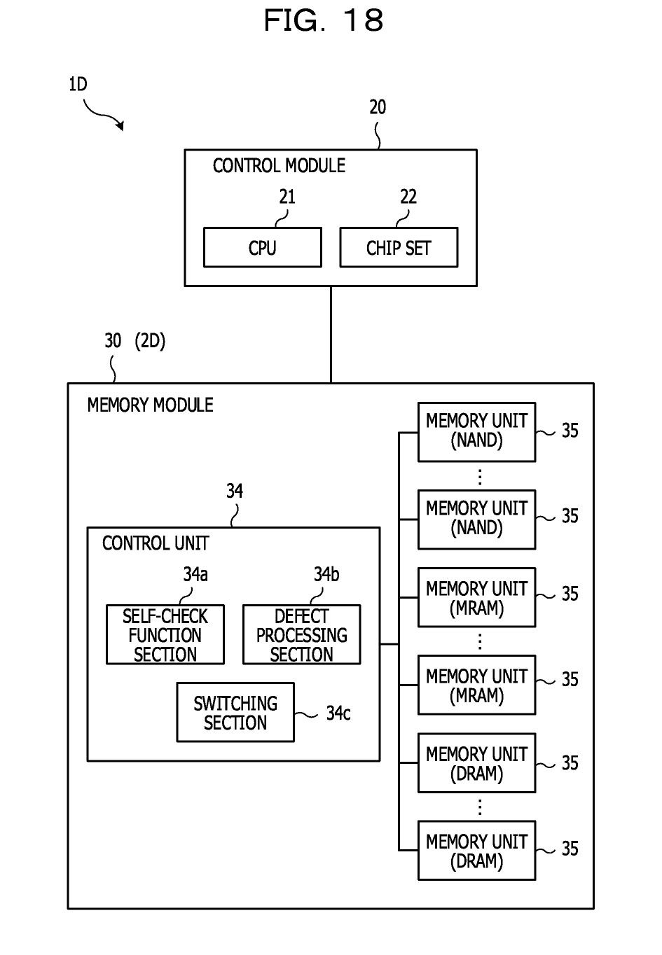

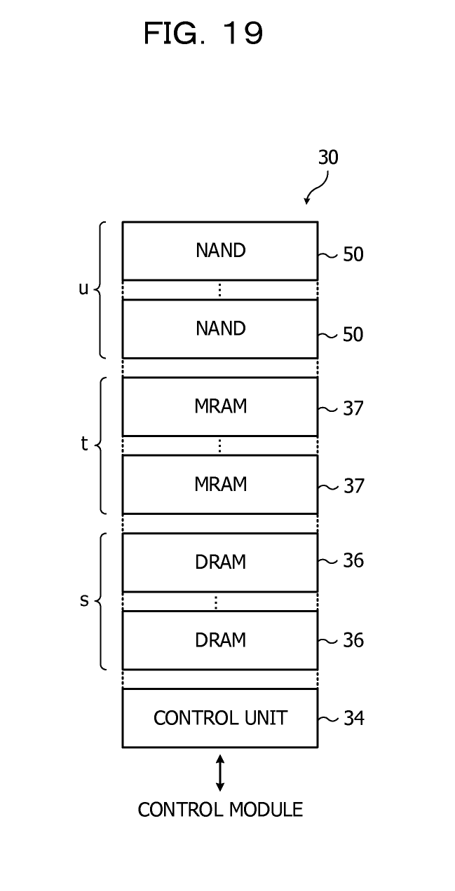

FIG. 18 and FIG. 19 are diagrams illustrating a fourth example of an electronic device. FIG. 18 is a diagram illustrating a configuration example of the electronic device, and FIG. 19 is a diagram illustrating a configuration example of a memory module of the electronic device.

An electronic device 1D illustrated in FIG. 18 includes a control module 20 and a memory module 30 having a stacked structure 2D. The electronic device 1D is different from the electronic device 1A in that the electronic device 1D further includes, in addition to memory units 35 (memory blocks or memory layers) of DRAMs and MRAMs, memory units 35 (memory blocks or memory layers) of NANDs. As illustrated in FIG. 19, the memory module 30 of the electronic device 1D may have a hierarchical structure including a plurality of (s) DRAM layers 36, a plurality of (t) MRAM layers 37, and a plurality of (u) NAND layers 50 that are stacked on the control unit 34.

In the memory module 30 of the electronic device 1D, a memory area 30a having a three-dimensional structure illustrated in FIG. 7 is realized by DRAMs, MRAMs, and NANDs. In the memory module 30 of the electronic device 1D, the switches 38 are provided in the arrangement illustrated in FIG. 8 or FIG. 9, or in an arrangement obtained by combining the arrangements illustrated in FIG. 8 and FIG. 9, so that switching of supply and cut-off of power in units of the memory layer 35b or in units of the memory blocks 35a is enabled.

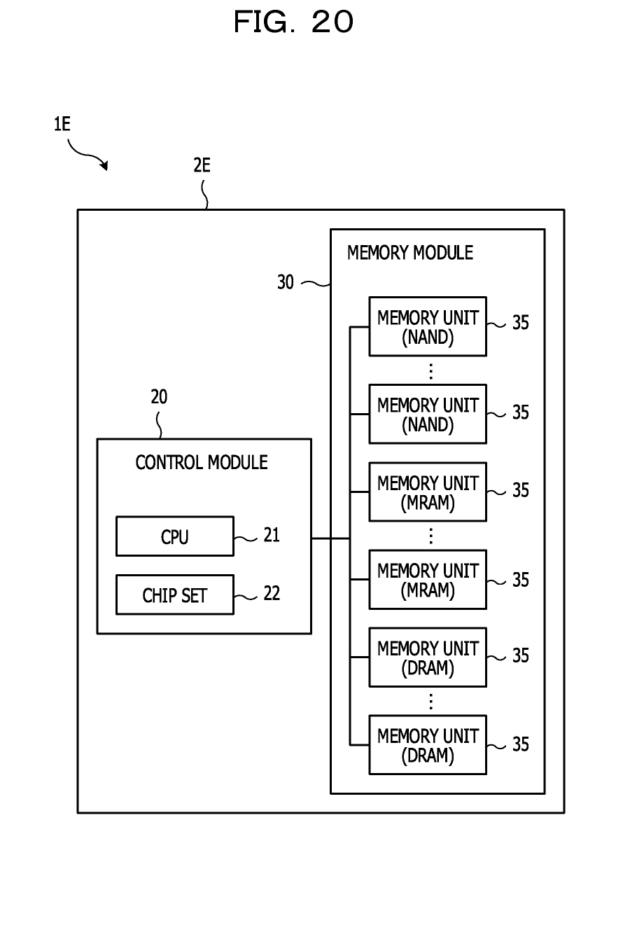

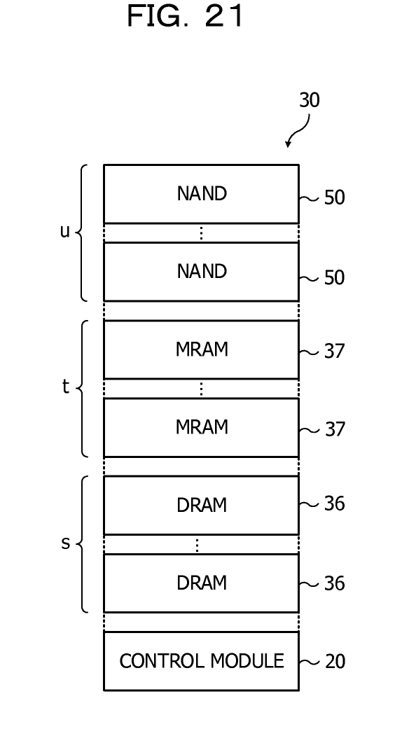

FIG. 20 and FIG. 21 are diagrams illustrating a fifth example of an electronic device. FIG. 20 is a diagram illustrating a configuration example of the electronic device, and FIG. 21 is a diagram illustrating a configuration example of a memory module of the electronic device.

An electronic device 1E illustrated in FIG. 20 has a stacked structure 2E including a control module 20 and a memory module 30. The electronic device 1E is different from the above-described electronic device 1B in that the electronic device 1E further includes, in addition to memory units 35 (memory blocks or memory layers) of DRAMs and MRAMs, memory units 35 (memory blocks or memory layers) of NANDs. For example, as illustrated in FIG. 21, the memory module 30 of the electronic device 1E may have a hierarchical structure including a plurality of (s) DRAM layers 36, a plurality of (t) MRAM layers 37, and a plurality of (u) NAND layers 50 that are stacked on the control module 20.

In the memory module 30 of the electronic device 1E, a memory area 30a having a three-dimensional structure illustrated in FIG. 7 is realized by DRAMs, MRAMs, and NANDs. In the memory module 30 of the electronic device 1E, the switches 38 are provided in the arrangement illustrated in FIG. 8 or FIG. 9, or in an arrangement obtained by combining the arrangements illustrated in FIG. 8 and FIG. 9, so that switching of supply and cut-off of power in units of the memory layer 35b or in units of the memory blocks 35a is enabled.

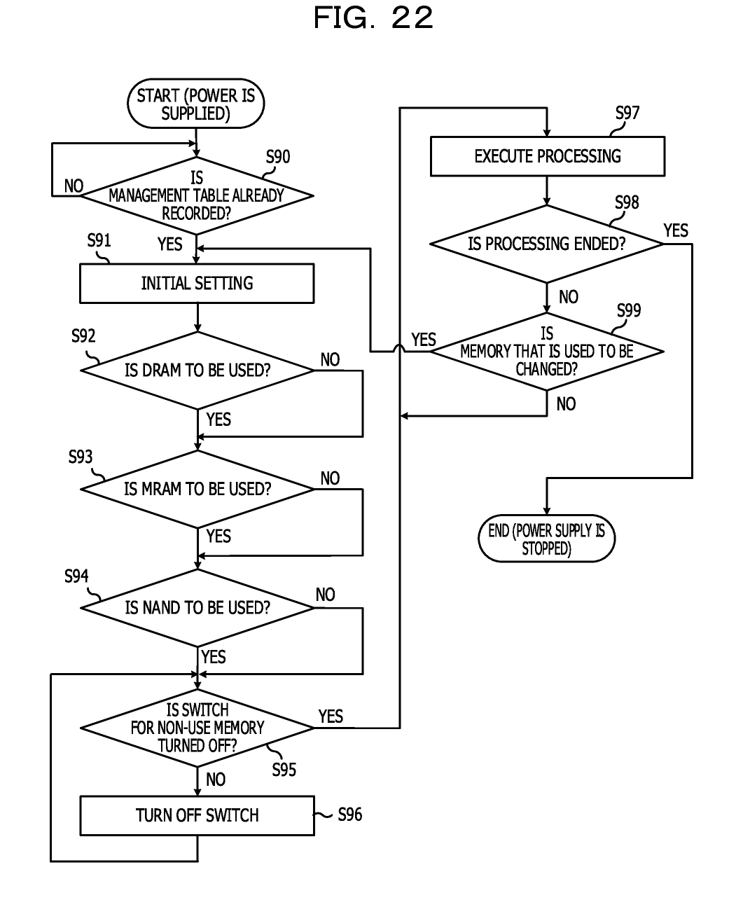

In the electronic device 1D, 1E, which of the DRAMs, the MRAMs, and the NANDs are used as a memory may be changed by the switches 38. An example of memory switching processing flow performed in the electronic device 1D, 1E having the above-described structure will be illustrated in FIG. 22.

In the electronic device 1D, 1E, first, whether or not information (ID information for the switches 38, the non-use memory instruction, the switch status, and the power supply status) of the management table 40 is recorded for all of the memory units 35 in the memory module 30 is determined (Step S90). If the information of the management table 40 is not recorded for all of the memory units 35 in the memory module 30, the processing of FIG. 11 is executed.

If the information is recorded in the management table 40, in the electronic device 1C, for the DRAMs, the MRAMs, and the NANDs of the memory units 35 in the memory module 30, initial setting is performed (Step S91). For example, mode register setting, defaulting and formatting of various types of settings, and the like, are performed.

In the electronic device 1D, 1E, information specifying which of the DRAMs, the RMAMs, and the NANDs are used as a main storage (a memory) is input. For example, a manufacturer or a user uses a predetermined input unit (a computer and a keyboard, a pointing device, or the like, connected to the computer) to input information that specifies a memory to be used to the electronic device 1D, 1E, or an electronic equipment including the electronic device 1D, 1E. In the electronic device 1D, 1E, based on the input information, instruction information for instructing to turn on or off the switches 38 connected to a selected or non-selected memory is generated by the CPU 21.

That is, in the electronic device 1D, 1E, based on the input information, whether or not the DRAMs are selected as a memory to be used (Step S92), whether or not the MRAMs are selected as a memory to be used (Step S93), and whether or not the NANDs are selected as a memory to be used (Step S94) are each determined.

Then, in the electronic device 1D, 1E, based on the determination result, instruction information for instructing to turn on or off the switches 38 connected to a selected or non-selected memory is generated and, based on the instruction information, the switches 38 connected to a memory that is not to be used are turned off (Step S95, S96). In the electronic device 1D, 1E, a memory for which the corresponding switch 38 is turned on is used, and various types of processing of the CPU 21 are executed (Step S97).

In the processing in Step S97, if the DRAMs and the MRAMs or the NANDs are selected as a memory that is to be used, the capacity of the DRAMs may be changed in accordance with the example illustrated in FIG. 12 and FIG. 13, or the example illustrated in FIG. 14. Also, in the processing in Step S97, if the MRAMs or the NANDs are not selected as a memory that is to be used and the DRAMs are selected as a memory that is to be used, the capacity of the DRAMs may be changed in accordance with the example of FIG. 17. Also, for the MRAMs or the NANDs, in accordance with the example of the DRAMs, the capacity may be changed by switching the switches 38.

If all of various types of processing of the CPU 21 are ended (Step S98), power supply to the electronic device 1D, 1E is stopped. If all of various types of processing of the CPU 21 are not ended (Step S98), and then, there is no change in a memory that is to be used (Step S99), the processing of Step S97 and subsequent process steps is executed. If all of various types of processing of the CPU 21 are not ended (Step S98), and then, the memory that is to be used is changed (Step S99), processing of Step S91 and subsequent steps is executed. Note that, if the DRAMs are included in the memory that is used after the memory is changed, and then, setting information for the DRAMs is stored in a volatile memory, such as an MRAM and the like, Step S91 may be skipped and the processing of Step S92 and subsequent steps may be executed.

Using the method described in the third embodiment, which of the DRAMs, the MRAMs, and the NANDs of the memory module 30 are used may be changed (selected) depending on use of the electronic device 1D, 1E, processing contents, and the like. For example, if a large capacity memory is desired to be used, the DRAMs may be selected and, if a nonvolatile memory is desired to be used for performing processing at high speed without losing data, the MRAMs may be selected.

Using the method described in the third embodiment, a memory appropriate to use, processing contents, and the like, may be selected, and also, power supply to a memory that is not used may be cut off. The electronic device 1D, 1E having broad utility may be realized and the power consumption thereof may be reduced.

Note that, in the above-described description, a CPU is illustrated as a processor. In addition to a CPU, a micro processing unit (MPU), a digital signal processor (DSP), an application specific integrated circuit (ASIC), a programmable logic device (PLD), or a combination of two or more of the foregoing processing units may be used as a processor. A processor may be a multiprocessor.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic device comprising:
a nonvolatile memory;
a volatile memory stacked over the nonvolatile memory; and
a controller configured to store setting information of the volatile memory in the nonvolatile memory before cutting off power supply to the volatile memory, and to set the setting information stored in the nonvolatile memory to the volatile memory after resuming power supply to the volatile memory.

2. The electronic device according to claim 1,
wherein the volatile memory includes a plurality of memory units, and
the controller configured to set the setting information stored in the nonvolatile memory to a first memory unit of the plurality of memory units after resuming power supply to the first memory unit.

3. The electronic device according to claim 1, further comprising:
a switch configured to switch supply and cut-off of power to the volatile memory from one to another,
wherein the controller switches on or off of the switch, based on instruction information, and performs supply or cut-off of power to the volatile memory.

4. The electronic device according to claim 1,
wherein the setting information includes setting information for a mode register of the volatile memory.

5. The electronic device according to claim 1, further comprising:
a plurality of stacked volatile memories, each of the volatile memories including a plurality of memory units,
wherein the controller selects, from the plurality of memory units, a memory unit to which power is supplied, based on instruction information, to control the capacity of the volatile memories.

6. The electronic device according to claim 5, further comprising:
a switch configured to switch supply and cut-off of power to the plurality of memory units from one to another,
wherein the controller switches on or off of the switch, based on the instruction information and performs supply or cut-off of power to the plurality of memory units, thereby controlling the volatile memories.

7. An electronic device comprising:
a nonvolatile memory;
a volatile memory stacked over the nonvolatile memory; and
a controller configured to select at least one of the volatile memory and the nonvolatile memory, based on instruction information, and use the selected memory as a main storage.

8. The electronic device according to claim 8, further comprising:
a switch configured to switch supply and cut-off of power to the volatile memory and the nonvolatile memory from one to another,
wherein the controller switches on or off of the switch, based on the instruction information, and uses at least one of the volatile memory and the nonvolatile memory as a main storage.

9. A method for controlling an electronic device including a nonvolatile memory and a volatile memory stacked over the nonvolatile memory, the method comprising:
storing setting information of the volatile memory in the nonvolatile memory before cutting off power supply to the volatile memory; and
setting the setting information stored in the nonvolatile memory to the volatile memory after resuming power supply to the volatile memory.
